(19) United States
(12) Patent Application Publication
(10) Pub. No.: US 2026/0095608 A1
(43) Pub. Date: Apr. 2, 2026

(54) TECHNIQUES FOR CONTENT RECOMMENDATION BASED ON USER ENGAGEMENT METRICS

(71) Applicant: NETFLIX, INC., Los Gatos, CA (US)

(72) Inventors: James Edward MCINERNEY, Maplewood, NJ (US); Nicole COLABELLA, Hope, RI (US); Kevin O'CONNOR, Dresden, ME (US); COREY WALDIN, Tualatin, OR (US)

(21) Appl. No.: 18/903,690

(22) Filed: Oct. 1, 2024

(51) Int. Cl. H04N 21/25; G06F 17/18; G06Q 30/0601; H04N 21/235

(52) U.S. Cl. CPC H04N 21/252; G06F 17/18; G06Q 30/0631; H04N 21/2353

(57) ABSTRACT

Techniques for content recommendation based on user engagement metrics include receiving user-content interaction data for a content item, calculating conditional survival times for the content item, determining one or more launch points within the content item based on the calculated conditional survival times, and annotating the content item with the one or more launch points. The one or more launch points are usable to generate recommendations for one or more users.

### BACKGROUND

### Technical Field

The embodiments of the present disclosure relate generally to computer science and signal processing, and more specifically, to techniques for content recommendation based on user engagement metrics.

### Description of the Related Art

A content recommendation system is a tool designed to deliver personalized content recommendations to users based on user interactions and preferences. Content recommendation systems are used across various digital platforms, such as video streaming services, online news portals, and e-commerce websites, to enhance user experience by tailoring content to user preferences. For example, in video streaming services such as Netflix, content recommendation systems analyze user viewing habits to recommend movies, TV shows, and other types of content that align with the user's preferences. Similar to video streaming services, online news portals can use content recommendation systems to recommend articles that match a user's reading history, while e-commerce platforms can recommend products based on a user's previous purchases and browsing behavior.

One conventional approach used in content recommendation systems is content-based filtering, which recommends contents similar to those a user has interacted with or liked in the past. For example, a user who has watched several science fiction movies could receive recommendations for other science fiction content. Content-based filtering is based on the attributes of the contents, such as genre, actors, directors, and/or the like, and the user's historical interactions with the attributes. Another conventional method in content recommendation systems is collaborative filtering, which recommends media content that is popular among similar users. For example, in a streaming service, a feature like “viewers who watched this also watched” is based on collaborative filtering, where the content recommendation system suggests movies or TV shows based on the viewing patterns of other users with similar tastes.

One drawback of conventional content recommendation systems is that conventional recommendation systems often overlook dynamic factors influencing user engagement, such as the temporal patterns of how users interact with content and/or the like. For example, conventional content recommendations systems do not account for when users are most likely to start or stop engaging with a specific content. A user may start watching a recommended content but then disengage shortly after, as conventional content recommendation systems do not consider the likelihood of sustained user interest in the content. Overlooking dynamic factors influencing user engagement can result in recommendations that fail to capture the nuances of viewer engagement over time, leading to reduced user satisfaction and retention in the recommendations made by the system.

As the foregoing illustrates, what is needed in the art are more effective techniques for content recommendation systems.

### SUMMARY

One embodiment of the present disclosure sets forth a computer-implemented method for processing user-content interaction data. The method includes receiving user-content interaction data for a content item, calculating conditional survival times for the content item, determining one or more launch points within the content item based on the calculated conditional survival times, and annotating the content item with the one or more launch points. The one or more launch points are usable to generate recommendations for one or more users.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to prior art is that the disclosed techniques account for dynamic factors influencing user engagement with content, such as the temporal patterns of user interaction with content. Based on conditional survival times and hazard rate calculations, the disclosed techniques more accurately predict when users are most likely to remain engaged with content, leading to more tailored and relevant recommendations. Another advantage of the disclosed techniques is the ability to improve user satisfaction and retention by determining locally optimal launch points that align with peak user engagement moments. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments of the present disclosure;

FIG. 2 is a block diagram of a content server that can be implemented in conjunction with the network infrastructure of FIG. 1, according to various embodiments of the present disclosure;

FIG. 3 is a block diagram of a control server that can be implemented in conjunction with the network infrastructure of FIG. 1, according to various embodiments of the present disclosure; and

FIG. 4 is a block diagram of an endpoint device that can be implemented in conjunction with the network infrastructure of FIG. 1, according to various embodiments of the present disclosure;

FIG. 5 is a block diagram of a computer-based system according to various embodiments;

FIG. 6 is a more detailed illustration of the engagement analysis module of FIG. 5, according to various embodiments;

FIG. 7 is a more detailed illustration of the recommendation application of FIG. 5, according to various embodiments;

FIG. 8 illustrates an example of the application of the engagement analysis module, according to various embodiments;

FIG. 9 sets forth a flow diagram of method steps for processing user-content interaction data and generating annotated content items, according to various embodiments;

FIG. 10 sets forth a flow diagram of method steps for calculating conditional survival times for a content item and determining launch points, according to various embodiments; and

FIG. 11 sets forth a flow diagram of method steps for generating recommendations using annotated content items based on user inputs, according to various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

### System Overview

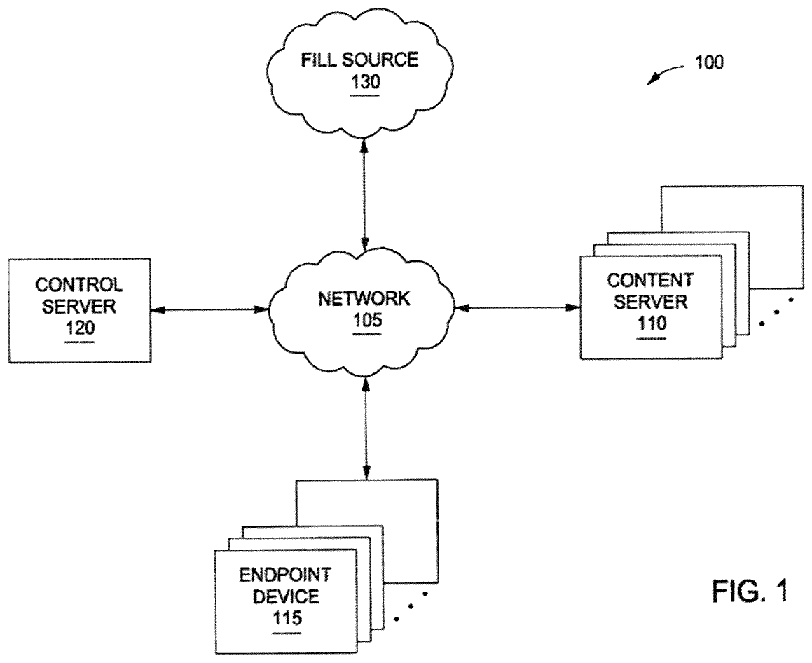

FIG. 1 illustrates a network infrastructure 100 used to distribute content to content servers 110 and endpoint devices 115, according to various embodiments of the invention. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, database, and server application 217 configured to communicate with the control server 120 to determine the location and availability of various files that are tracked and managed by the control server 120. Each content server 110 may further communicate with a fill source 130 and one or more other content servers 110 in order “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

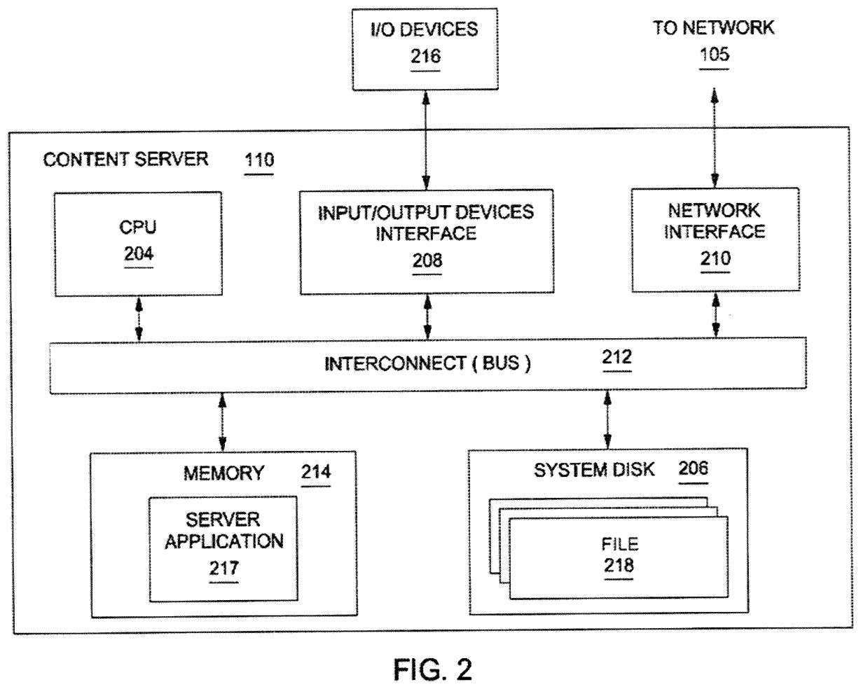

FIG. 2 is a block diagram of a content server 110 that may be implemented in conjunction with the network infrastructure 100 of FIG. 1, according to various embodiments of the present invention. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

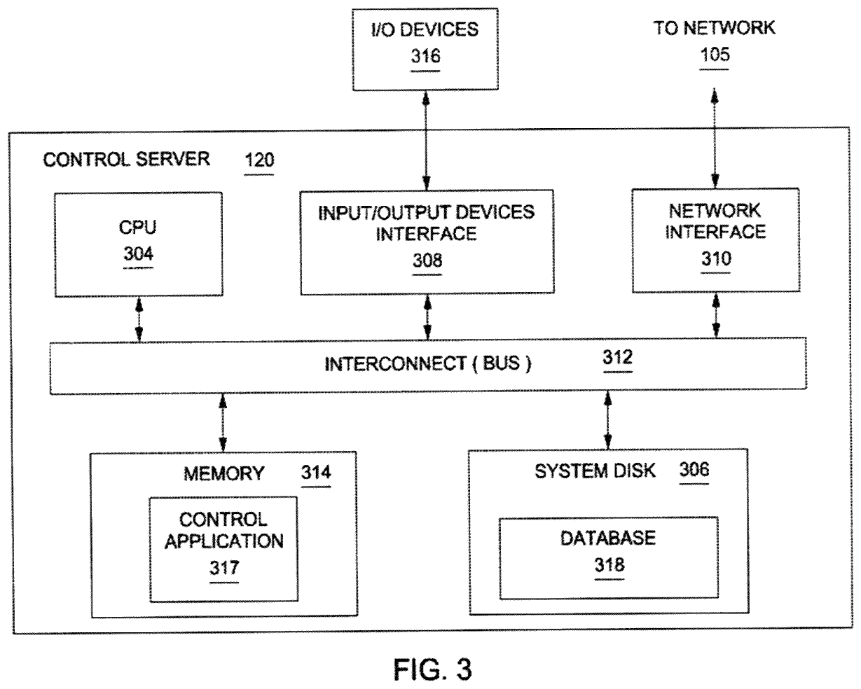

FIG. 3 is a block diagram of a control server 120 that may be implemented in conjunction with the network infrastructure 100 of FIG. 1, according to various embodiments of the present invention. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 206 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

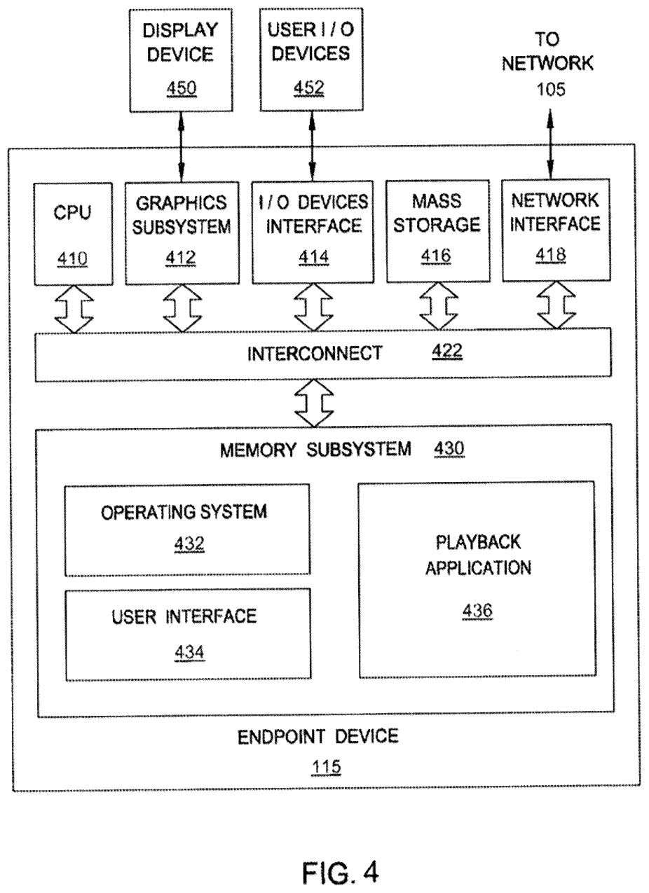

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage unit 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 436 is configured to request and receive content from the content server 110 via the network interface 418. Further, the playback application 436 is configured to interpret the content and present the content via display device 450 and/or user I/O devices 452.

### Content Recommendation Using User Engagement Metrics

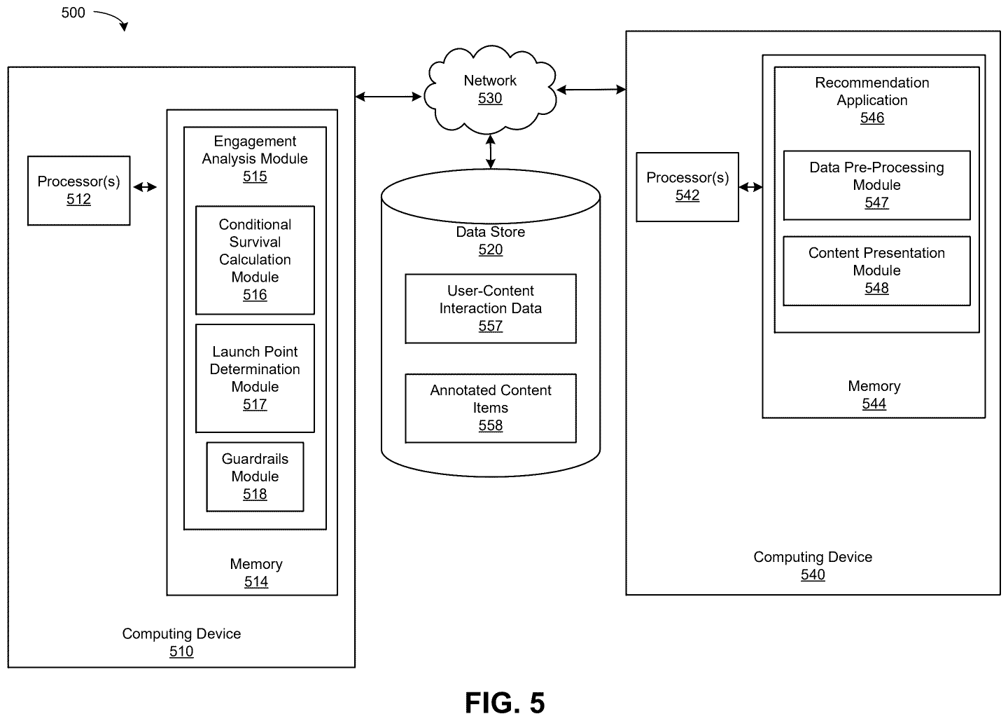

FIG. 5 is a block diagram of a computer-based system 500 according to various embodiments. As shown, computer-based system 500 includes, without limitation, computing devices 510 and 540, a data store 520, and a network 530. Computing device 510 includes, without limitation, one or more processors 512 and memory 514. Memory 514 includes, without limitation, an engagement analysis module 515. Engagement analysis module 515 includes, without limitation, a conditional survival calculation module 516, a launch point determination module 517, and a guardrails module 518. Data store 520 includes, without limitation, user-content interaction data 557 and annotated content items 558. Computing device 540 includes, without limitation, one or more processors 542 and memory 544. Memory 544 includes, without limitation, a recommendation application 546. Recommendation application 546 includes, without limitation, a data pre-processing module 547 and a content presentation module 548. Although FIG. 5 is described in the context of content recommendation systems, it is understood that the disclosed techniques are also applicable to other areas of content analysis and personalization, such as adaptive content delivery systems, targeted advertising platforms, dynamic user interface customization, and personalized educational content applications, and/or the like.

Computing device 510 shown herein is for illustrative purposes only, and variations and modifications in the design and arrangement of computing device 510, without departing from the scope of the present disclosure. For example, the number of processors 512, the number of and/or type of memories 514, and/or the number of applications and or data stored in memory 514 can be modified as desired. In some embodiments, any combination of processor(s) 512 and/or memory 514 can be included in and/or replaced with any type of virtual computing system, distributed computing system, and/or cloud computing environment, such as a public, private, or a hybrid cloud system.

Each of processor(s) 512 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 512 can be any technically feasible hardware unit capable of processing data and/or executing software applications. During operation, processor(s) 512 can receive user input from input devices (not shown), such as a keyboard or a mouse.

Memory 514 of computing device 510 stores content, such as software applications and data, for use by processor(s) 512. As shown, memory 514 includes, without limitation, engagement analysis module 515. Memory 514 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 514. The storage can include any number and type of external memories that are accessible to processor(s) 512. For example, and without limitation, the storage can include a Secure Digital Card, an external Flash memory, a portable CD-ROM, an optical storage device, a magnetic storage device, and/or any suitable combination of the foregoing.

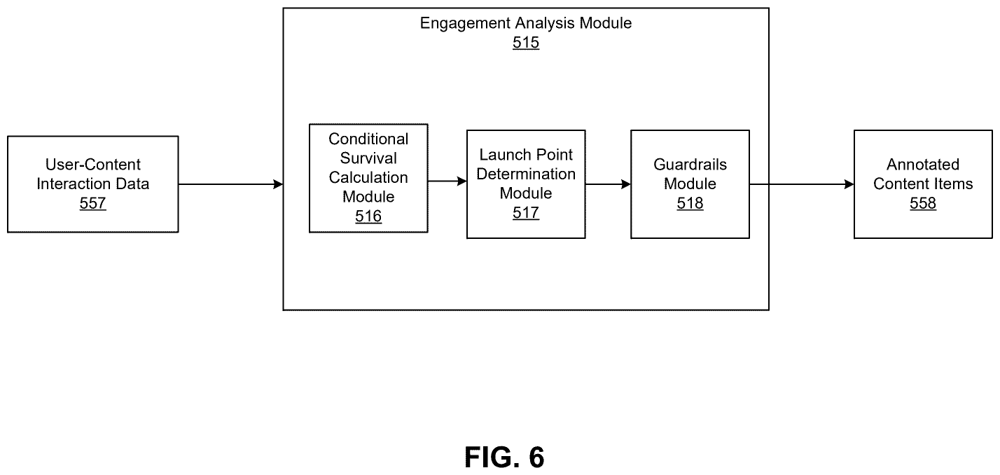

Engagement analysis module 515 is stored in memory 514 and is executed by processor(s) 512. Engagement analysis module 515 includes, without limitation, a conditional survival calculation module 516, a launch point determination module 517, and a guardrails module 518. Engagement analysis module 515 uses user content interaction data 557 to generate annotated content items 558. User-content interaction data 557 includes information capturing when users engage and disengage with content, peaks in engagement or points of disengagement, and/or the like. For example, user-content interaction data 557 can include engagement time series data that records timestamps of when a user starts, or stops watching content, as well as moments of peak engagement or disengagement peaks, such as segments where users commonly stop watching or skip forward. User-content interaction data 557 provides insights into how users interact with specific segments of content, helping to identify patterns that can inform engagement analysis module 515. Annotated content items 558 includes metadata that identifies recommended launch points designed to engage users for each piece of content. Annotated content items 558 can include specific timestamps or segments within the content that have been determined to improve user engagement, based on prior user-content interaction data 557. For example, annotated content items 558 can highlight the most compelling scene to start playback or segments that are most likely to retain user interest. Engagement analysis module 515 is discussed in greater detail below in conjunction with FIGS. 6, 8, and 9-10.

Conditional survival calculation module 516 uses various signal processing algorithms to analyze user-content interaction data 557 and calculate conditional survival times, which indicate how long a user is likely to continue engaging with content beyond specific points in time. In some embodiments, conditional survival calculation module 516 uses various engagement metrics, such as survival analysis and/or the like, to estimate the time a user will remain engaged with a video or other media content after watching a particular content segment. For example, conditional survival calculation module 516 analyzes time series data included in user-content interaction data 557, such as play, pause, rewind, skip events, and/or the like, to detect patterns that reveal when users are most likely to disengage from the content. Conditional survival calculation module 516 can also consider contextual factors such as the genre of the content, the time of day the content is consumed, the type of device used, and/or the like, to refine the calculation of conditional survival times. In various embodiments, conditional survival calculation module 516 uses machine learning models to calculate conditional survival times by predicting engagement drop-offs by comparing current user behavior against historical user-content interaction data 557 from similar users. Additionally, conditional survival calculation module 516 can adjust the calculation of conditional survival times based on external factors, such as the overall content length or specific significant events within the content item (e.g., plot twists or action scenes), which can influence user engagement.

Launch point determination module 517 processes conditional survival times generated by conditional survival calculation module 516 to determine a set of launch points within each content item that are most likely to maintain user interest. The launch points are determined based on the likelihood of maintaining user interest, ensuring that users are introduced to the most engaging segments of each content. In various embodiments, launch point determination module 517 analyzes the conditional survival times to determine specific timestamps or content segments where users are most likely to stay engaged, reducing the risk of early disengagement. In at least one embodiment, launch point determination module 517 considers different user demographics or viewing contexts. For example, launch point determination module 517 can determine different launch points for users who typically prefer fast-paced content versus users who engage more with character development scenes. Launch point determination module 517 can further refine launch points by analyzing trends across similar types of content, such as identifying that users often disengage during lengthy dialogue scenes in action movies, thus recommending a launch point just before a major action scene instead. In various embodiments, launch point determination module 517 determines launch points based on external factors, such as the time of day or the type of device being used, recognizing that users can have different engagement patterns, for example, when watching on a mobile device during a commute versus at home on a TV.

Guardrails module 518 uses content-specific rules and filters to the determined launch points to prevent the selection of launch points that could reveal critical plot details or assumed knowledge in the content, which could diminish the user experience. For example, in a mystery or thriller series, guardrails module 518 can exclude launch points that occur just before or during the reveal of a major plot twist, ensuring that users are not introduced to the content at a moment that would spoil the surprise. Similar to mystery or thriller series, in a dramatic film, guardrails module 518 can filter out launch points leading to a climactic moment, such as a character's death or a key confession. Guardrails module 518 also addresses anti-spoilers, where context that should remain unknown to maintain suspense or emotional impact is inadvertently revealed. For example, guardrails module 518 can avoid launching content at a point where the identity of a character's true antagonist is discussed before the viewer has had a chance to experience the build-up. In at least one embodiment, guardrails module 518 enforces rules that prevent launching at content segments that assume prior knowledge of earlier episodes or films in a series, which could confuse or alienate first-time users. In various embodiments, guardrails module 518 can use metadata tags associated with content segments to identify and exclude potentially problematic launch points. For example, scenes tagged with keywords like “plot twist,” “final showdown,” or “character reveal” could be automatically flagged and avoided as launch points. In some embodiments, guardrails module 518 dynamically adjust guardrails based on user preferences or viewing history. For example, a user who consistently watches a series from the beginning can trigger stricter guardrails to ensure that content item does not launch at a point that can spoil previous episodes.

Network 530 can be a wide area network (WAN), such as the Internet, a local area network (LAN), a cellular network, and/or any other suitable network. Computing devices 510 and 540 and data store 520 are in communication over network 530. For example, network 530 can include any technically feasible network hardware suitable for allowing two or more computing devices to communicate with each other and/or to access distributed or remote data storage devices, such as data store 520.

Computing device 540 shown herein is for illustrative purposes only, and variations and modifications in the design and arrangement of computing device 540, without departing from the scope of the present disclosure. For example, the number of processors 542, the number of and/or type of memories 544, and/or the number of applications and or data stored in memory 544 can be modified as desired. In some embodiments, any combination of processor(s) 542 and/or memory 544 can be included in and/or replaced with any type of virtual computing system, distributed computing system, and/or cloud computing environment, such as a public, private, or a hybrid cloud system.

Each of processor(s) 542 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 542 can be any technically feasible hardware unit capable of processing data and/or executing software applications. During operation, processor(s) 542 can receive user input from input devices (not shown), such as a keyboard or a mouse.

Memory 544 of computing device 540 stores content, such as software applications and data, for use by processor(s) 542. As shown, memory 544 includes, without limitation, a recommendation application 546 and a cache 548. Memory 544 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 544. The storage can include any number and type of external memories that are accessible to processor(s) 542. For example, and without limitation, the storage can include a Secure Digital Card, an external Flash memory, a portable CD-ROM, an optical storage device, a magnetic storage device, and/or any suitable combination of the foregoing.

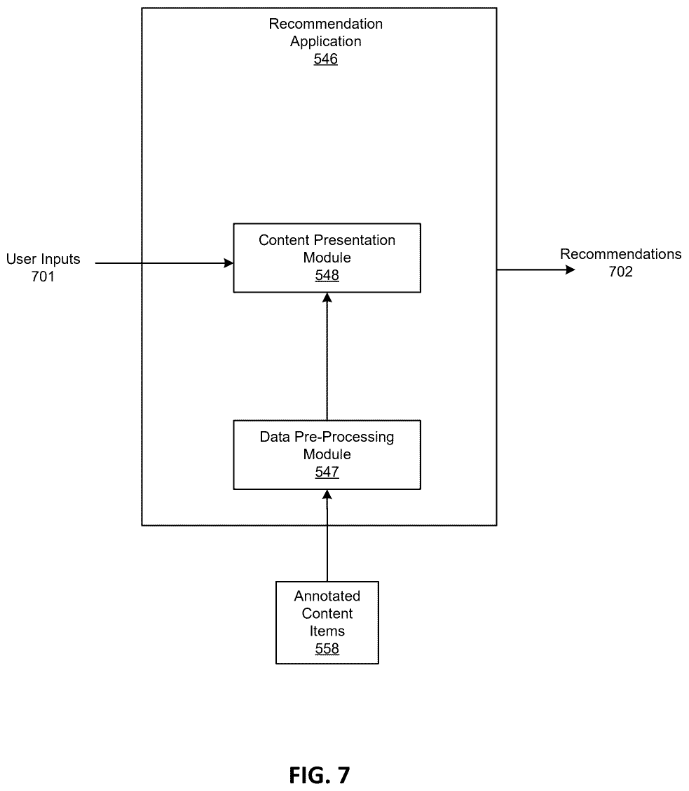

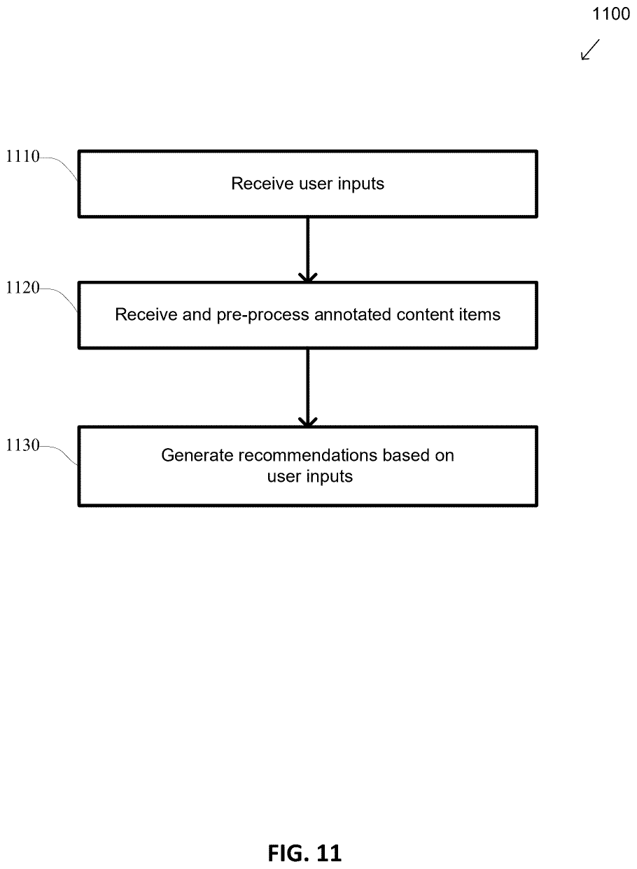

As shown, recommendation application 546 is stored in memory 544 and executes on processor(s) 542. Recommendation application 546 includes, without limitation, a data pre-processing module 547 and a content presentation module 548. Recommendation application 546 receives one or more user inputs via one or more I/O device(s) (not shown). Based on the one or more user inputs, recommendation application 546 uses annotated content items 558 to generate one or more recommendations. Recommendation application 546 is discussed in greater detail below in conjunction with FIGS. 7 and 11.

Data pre-processing module 547 pre-processes annotated content items 558 for use in the recommendation application. In various embodiments, data pre-processing module 547 pre-processes annotated content items 558 by cleaning, organizing, and transforming annotated content items 558 into a format that can be used by content presentation module 548. For example, the pre-processing can include normalizing data formats, such as ensuring consistent timestamp formats across different content, filtering out irrelevant or redundant information, such as duplicate annotations or outdated metadata, and integrating the annotated launch points with user profiles and interaction histories to enhance personalization. Additionally, data pre-processing module 547 can categorize content segments based on genre, theme, or audience suitability, and adjust metadata to align with current viewing trends or platform requirements.

Content presentation module 548 processes user inputs and generates recommendations to users based on the pre-processed annotated content items 558. Content presentation module 548 generates and displays content recommendations that are tailored to individual user preferences and engagement patterns. For example, content presentation module 548 can arrange recommended content items in a visually appealing layout on a user interface, highlight the optimal launch points within videos, and dynamically update the recommendations in real-time based on user inputs, such as clicks, views, or skips. Additionally, content presentation module 548 can apply contextual adjustments, such as prioritizing certain content item during specific times of the day or based on the user's current device. In some examples, content presentation module 548 generates recommendations, which include a content list with each item in the list starting at a determined launch point, rather than the initial point of the content, so that users are engaged with the most compelling content segments upon launching the selected content. Content presentation module 548 can also generate recommendations, which include highlight reels or teasers that feature engaging moments from the content, motivating users to watch the full version by showcasing the most engaging content segments.

FIG. 6 is a more detailed illustration of the engagement analysis module 515 of FIG. 5, according to various embodiments. Engagement analysis module 515 processes user-content interaction data 557 and generates annotated content items 558. As shown, engagement analysis module 515 includes, without limitation, conditional survival calculation module 516, launch point determination module 517, and guardrails module 518.

Conditional survival calculation module 516 processes user-content interaction data 557 and calculates conditional survival times. In various embodiments, user-content interaction data 557 includes time series data that captures user related events, such as engagement, disengagement, churn, and/or the like. Each event in the time series data is associated with a specific time T, which can either be observed directly (e.g., when a user stops watching content) or censored (e.g., when a user is still engaged at the end of the observation period). The survival probability S(t) is then defined as the probability that a user continues to engage with the content item beyond a certain time t, which can be mathematically expressed as:

$$S ( t ) = p ( T \geq t ) \qquad ( Equation 1 )$$

Equation 1 calculates the likelihood that the event time T, such as disengagement and/or the like, occurs at or after a given time t. The survival probability helps in understanding how likely a user will remain engaged with the content item as time progresses. Complementing the survival probability is the hazard function h(t), which describes the instantaneous rate at which users are likely to disengage from the content item at a given time t, provided the users have remained engaged up to that point. The hazard function is defined as:

$$h ( t ) = lim\_ ( Δ t \to 0 ) ( P ( t \leq T < t + Δ t \vert T \geq t ) ) / Δ t \qquad ( Equation 2 )$$

Equation 2 measures the conditional probability that a user will disengage within the small time interval [t,t+Δt), given that the user has stayed engaged until time t. The hazard rate can identify moments within the content item where users are most likely to disengage with the content. Alternatively, the hazard function can be expressed in terms of the survival probability S(t) as:

$$h ( t ) = - \frac{d [ ln ( S ( t ) ) ]}{dt} \qquad ( Equation 3 )$$

Equation 3 shows that the hazard function can be derived from the rate of change of the logarithm of the survival probability. Equation 3 provides a direct way to compute the hazard rate from survival probabilities. Additionally, the concept of interval hazard can be used to evaluate user engagement over a specific content interval rather than just at a single point in time. The cumulative hazard H(t) over time is calculated as:

$$H ( t ) = {\int }_{0}^{t} h ( u ) d u \qquad ( Equation 4 )$$

The interval hazard J(t₁,t₂), which assesses the quality of content engagement between two points in time t₁ and t₂, is defined as:

$$J ( {t}_{1} , {t}_{2} ) = p ( {t}_{1} \leq T < {t}_{2} \vert T \geq {t}_{1} ) = H ( {t}_{2} ) - H ( {t}_{1} ) = ln ( \frac{s ( {t}_{1} )}{s ( {t}_{2} )} ) \qquad ( Equation 5 )$$

A low interval hazard indicates high user engagement within the specified time interval in a content, implying that the content during the interval is more likely to retain a user's attention. Interval hazard as described in Equation 5 provides a sliding window of fixed size. For example, the interval hazard can be used to assess where the most engaging three-minute segment is located in a content.

In various embodiments, calculating the continuous time cumulative hazard function H(t) is cumbersome. The Nelson-Aalen estimator is a non-parametric method used to estimate the cumulative hazard function in survival analysis, providing insights into the risk or hazard of an event occurring over time. The estimated cumulative hazard function, denoted as H\hat{ }(t), is calculated by summing the contributions from each observed time point T; up to t, where the contribution at each time point is the inverse of the number of units (e.g. the number of users who are still engaged with the content item and have not yet disengaged by that time) still at risk just before that time. The formula for the estimated cumulative hazard is:

$${H}^{\hat{}} ( t ) = {\sum }_{{T}_{j} \leq t} \frac{1}{Y ( {T}_{j} )} \qquad ( Equation 6 )$$

where Y(Tⱼ) is the number of users still engaged and at risk of disengaging just before time Tⱼ. In addition to the cumulative hazard, the Nelson-Aalen estimator can be used to estimate the interval hazard J\hat{ }(t₁,t₂) as given by Equation 5, which measures the hazard accumulated between two specific time points, t₁ and t₂. The variance σ\hat{ }²(t) of the cumulative hazard estimator is also calculated to understand the uncertainty in the hazard estimate. The variance is determined by summing the squares of the inverse of the number of units at risk at each time point, which provides a measure of the reliability of the cumulative hazard estimate. The formula for the variance is:

$${σ}^{\hat{} 2} ( t ) = {\sum }_{{T}_{j} \leq t} \frac{1}{{Y ( {T}_{j} )}^{2}} \qquad ( Equation 7 )$$

The variance provides a measure of the reliability of the cumulative hazard estimate. Similar to the variance of the cumulative hazard estimator, the variance for the interval hazard estimator can be calculated, giving insight into the uncertainty of the hazard within a specific time interval. The Nelson-Aalen estimator satisfies the asymptotic normality property, meaning that as the sample size n becomes large, the difference between the estimated cumulative hazard H\hat{ }(t) and the true hazard H(t) follows a normal distribution. The asymptotic normality property allows for statistical inference, such as constructing confidence intervals and conducting hypothesis tests. The normalized difference, given by {square root over (n(H\hat{ }(t)−H(t)))}, converges in distribution to a normal distribution with mean zero and variance σ²(t), providing a framework for making inferences about the hazard rate based on the observed data.

Interval hazard does not account for the fact that some users could be inherently more likely to disengage from content item than others due to factors that are not directly observed in user-content interaction data 557. For example, some users can be more prone to disengage from content item because the users have a short attention span, prefer different genres, or are simply distracted by the environment. Such factors are not always captured in the observable data, such as the user's watch history or the content's attributes. Frailty refers to unobserved heterogeneity or random effects that can influence the survival probability of users. To remove frailty from survival analysis, the hazard function is adjusted by considering a random variable Z, which represents the unobserved frailty. The conditional hazard function given frailty Z is expressed as:

$$h ( t \vert Z ) = Z λ ( t ) \qquad ( Equation 8 )$$

where λ(t) is the baseline hazard rate (the rate at which disengagement occurs) without considering frailty, and Z scales the baseline hazard rate based on the unobserved factors. The survival function, considering frailty, is then given by:

$$S ( t \vert Z ) = {e}^{- Z {\int }_{0}^{t} λ ( u ) d u} \qquad ( Equation 9 )$$

representing the probability that a user with a specific frailty Z remains engaged with the content item until time t. When averaging over the entire user population (considering the distribution of frailty Z), the survival function becomes

$$S ( t ) = 𝔼 [ {e}^{- Z {\int }_{0}^{t} λ ( u ) d u} ] \qquad ( Equation 10 )$$

which accounts for the fact that different users have different levels of frailty. The Laplace transform of the frailty distribution [symbol] (c)= [symbol] [e^{-cZ}] is used to simplify the calculations. The population hazard rate, which considers the effect of frailty on the entire population, is then given by:

$$μ ( t ) = \frac{λ ( t ) ( - {ℒ}^{′} ( {\int }_{0}^{t} λ ( u ) d u ) )}{ℒ ( {\int }_{0}^{t} λ ( u ) d u )} \qquad ( Equation 11 )$$

The adjusted hazard rate with frailty accounts for the variability in engagement behavior that is not directly observed.

In various embodiments, the Kaplan-Meier estimator is used to estimate the survival function in non-parametric way. The Kaplan-Meier estimator is useful when analyzing time-to-event data, such as how long users remain engaged with content item before disengaging. The Kaplan-Meier estimator, including the discrete form of the estimator, accounts for “ties,” which occur when multiple events, such as disengagements and/or the like, happen at the same time point. The Kaplan-Meier estimator calculates the estimated survival function S\hat{ }(t), representing the probability that a user remains engaged with the content item up to a specific time t. The estimated survival function is calculated by taking the product of survival probabilities across all observed time points where events like disengagements occur. Mathematically, the calculation is expressed as:

$$S \hat{} ( t ) = {\prod }_{{T}_{j} \leq t} ( 1 - λ ( {T}_{j} ) ) \qquad ( Equation 12 )$$

$$where$$

$$λ ( {T}_{j} ) = \frac{d ( {T}_{j} )}{Y ( {T}_{j} )} \qquad ( Equation 13 )$$

is the discrete estimate of the hazard function with d(Tⱼ) being the number of users disengaging at time Tⱼ. The product accumulates the probabilities of survival across all time points up to t, adjusting for the number of events at each step. The estimated survival function can be refined to start from a specific time k within the content, making the estimated survival function useful when evaluating survival probabilities from a particular point in the content. The estimated survival function from a specific launch point is calculated as:

$${S}_{k}^{\hat{}} ( t ) = {\prod }_{{t}^{′} = k}^{t} ( 1 - {z}_{fix} λ ( {t}^{′} ) ) \qquad ( Equation 14 )$$

where z_{fix} a fixed adjustment factor to account for robustness or frailty in the estimation, providing a more tailored understanding of how likely a user is to remain engaged with content item launching from a specific moment. Greenwood's formula is used to calculate the variance σ\hat{ }²(t) of the estimated survival function, which provides a measure of uncertainty or variability in the survival estimates. The formula is given by:

$${σ}^{\hat{} 2} ( t ) = S {\hat{} ( t )}^{2} {\sum }_{{T}_{j} \leq t} \frac{{d}_{j}}{Y ( {T}_{j} ) ( Y ( {T}_{j} ) - {d}_{j} )} \qquad ( Equation 15 )$$

The variance calculated in Equation 15 accounts for the number of events and the number of users at risk at each time step, helping to quantify the reliability of the survival estimates. Using the asymptotic normality of the Kaplan-Meier estimator, confidence intervals for the estimated survival function can be constructed. The confidence intervals provide a range within which the true survival probability is likely to lie, accounting for statistical uncertainty. The confidence interval is calculated as:

$$S \hat{} ( t ) \pm {z}_{1 - \frac{α}{2}} {σ}^{\hat{}} ( t ) \qquad ( Equation 16 )$$

$$where {z}_{1 - \frac{α}{2}}$$

is the critical value from the standard normal distribution, corresponding to the desired confidence level (e.g., 95%).

In operation, conditional survival calculation module 516 collects survival time series data T_{1:N} for a group of users included in user-content interaction data 557, where N represents the number of users. Survival time series data includes the times at which users engage with or disengage from the content. Using the collected survival time series data, conditional survival calculation module 516 calculates the discrete hazard λ(t) at each time point t using Equation 13. After calculating the discrete hazard, conditional survival calculation module 516 adjusts the hazard to account for frailty. Conditional survival calculation module 516 includes frailty by introducing a random variable Z, which scales the baseline hazard λ(t) based on unobserved characteristics of the users. The adjusted hazard function μ(t) considering frailty is calculated using the formula

$$μ ( t ) = \frac{λ ( t ) ( {v ( 1 + \frac{A ( t )}{v} )}^{m + 1} )}{m ρ} \qquad ( Equation 17 )$$

where v is a parameter that adjusts for the degree of frailty, A(t) is an accumulated adjustment factor that accounts for various unobserved influences on user engagement, and m and ρ are additional parameters that further adjust for frailty. In various embodiments, the accumulated adjustment factor A(t) is calculated using the discrete Nelson-Aalen estimator. The Nelson-Aalen estimator sums up the hazard contributions at each time point from the start up to time t. Specifically, for each time point s within the range 1≤s≤t, the contribution is the ratio

$$\frac{{d}_{s}}{{n}_{s}} ,$$

where dₛ represents the number of failures (or events, such as user disengagements) occurring exactly at time s and nₛ represents the number of units (or users) still at risk just before time s, meaning the users have not yet experienced the event by time s. The Nelson-Aalen estimator accumulates the hazard contributions over time, providing a cumulative measure of the risk that has been observed up until time t. Mathematically, the accumulated adjustment factor A (t) is the sum:

$$A ( t ) = {\sum }_{s = 1}^{t} \frac{{d}_{s}}{{n}_{s}} \qquad ( Equation 18 )$$

In some examples, m=5 and v=1 as fixed parameters, and p is determined by a grid search over the range [0.01, 5] such that the population of users, after adjusting for frailty that interacts with all of a content, matches a target percentage, such as 50%. Conditional survival calculation module 516 then integrates the frailty-adjusted hazard A (t) over the population to determine the population hazard rate, reflecting the overall likelihood of disengagement across the entire user base.

In various embodiments, for every candidate launch point k=1, . . . , T, conditional survival calculation module 516 uses the discrete Kaplan-Meier estimator to calculate the survival probabilities S\hat{ }ₖ(t) using Equation 14 with A replaced with the frailty adjusted hazard function u calculated in Equation 17. In some examples, for each content, such as movie, series episode, and/or the like, a sweep is conducted over the values of z_{fix} in the range [0.01, 150] to yield groups of content segments with maximum lengths of 2 minutes, 6 minutes, and 12 minutes. The sweep provides a set of options to cater to different user preferences regarding patience and content consumption. For example, the frailty setting that yields a set of content segments with a maximum length of 2 minutes presents more immediate gratification and less narrative intrigue compared to the longer content segments. Conditional survival calculation module 516 then calculates conditional survival times c(k) (e.g., conditional survival rates), which signifies the minimum time after the launch point k where the probability of users disengaging with a content item is still below a pre-set certain probability threshold p∈(0,1]. The conditional survival function is then given by:

$$c ( k ) = {inf}_{t} ( ( 1 - {\hat{S}}_{k} ( t ) ) \geq p ) - k \qquad ( Equation 19 )$$

The threshold p is the threshold probability of disengagement that the content recommendation system 500 aims to avoid. For example, the threshold can represent the maximum allowable risk of disengagement for content item to still be considered engaging. In some examples, the parameter p represents the fraction of interest for the conditional survival calculations. A median user with p=0.5 typically engages to the end of most content item in unadjusted survival data, resulting in censorship. Hence, in order to focus instead on users in the population who are more sensitive to churn, conditional survival calculation module 516 sets parameter p to 0.25, although any value within the range of 0.1 to 0.3 is suitable as long as the value does not result in censored survival.

Launch point determination module 517 processes conditional survival times for each content item and determines one or more launch points. In various embodiments, launch point determination module 517 begins with smoothing conditional survival times c(k), k=1, . . . , T and generating smoothed conditional survival times co (k), k=1, . . . , T, where σ is a smoothing parameter. In at least one embodiment, the smoothing is achieved through the application of a 1D Gaussian blur, which smooths the time-series data of conditional survival times, helping to highlight broader trends while reducing the influence of minor fluctuations. The Gaussian blur is applied with varying σ values, where σ represents the standard deviation of the Gaussian kernel. A larger σ value results in broader smoothing, meaning that the curve is averaged over a wider range of conditional survival time points, thus emphasizing longer-term trends over short-term fluctuations. The smoothing starts with the initial value σ=90 seconds, meaning the conditional survival times are initially smoothed over a range of 90 seconds, which captures general engagement patterns but can overlook more subtle, short-term changes in user behavior. The σ value is then gradually reduced according to the schedule [90,60,30,15] seconds. Each reduction in σ narrows the smoothing window, allowing the analysis to focus on increasingly finer details in the engagement patterns. For example, at σ=60 seconds, the smoothing window is narrower, focusing on trends that are evident over a one-minute span, thus balancing between broader trends and finer engagement details. At σ=30 seconds, the smoothing captures even more localized engagement trends, such as spikes in user interest around specific content segments or moments within the content. At σ=15 seconds, the smoothing is minimal, allowing to detect precise points of engagement or disengagement within the content, such as key plot twists or action sequences.

Once launch point determination module 517 smooths the values of conditional survival times, launch point determination module 517 determines local optima in the smoothed conditional survival function c_{σ}(k). The local optima are points where c_{σ}(k) reaches a local maximum, indicating a segment in the content item where user engagement is particularly high. The set of locally optimal launch points is described as:

$$ℳ = \{ m {\vert \frac{d {c}_{σ}}{d k} \vert}_{k = m} = 0 , \frac{{d}^{2} {c}_{σ}}{d {k}^{2}} {\vert}_{k = m} < 0 \} . \qquad ( Equation 20 )$$

In some embodiments, the set [symbol] of local optima m is determined numerically, for example, at a fine granularity of 1 second. For each smoothed conditional survival times c_{σ}(k), k=1, . . . , T, launch point determination module 517 checks to see if the smoothed conditional survival times meet the following criteria: (i) The first derivative

$$\frac{d {c}_{σ}}{d k} at k = m$$

is zero, indicating that the point is either a peak or a trough. (ii) The second derivative

$$\frac{{d}^{2} {c}_{σ}}{{dk}^{2}} at k = m$$

is negative, confirming that the launch point is a local maximum, representing a peak in user engagement. In some examples, the first derivative and second derivatives of c_{σ} are numerically calculated by looking at change in values with the granularity of 1 second. In various embodiments, after determining the local optima m, launch point determination module 517 carries out a curvature adjustment to further refine local optima as follows

$${m}^{∼} = m - η \sqrt{\frac{1}{r}} \qquad ( Equation 21 )$$

where η is an adjustment parameter (e.g., η=1) and r is the second derivative of c_{σ} with respect to k at the point m. Equation 21 adjusts the position of the local optima based on the curvature of the conditional survival function. The second derivative r indicates how sharply the conditional survival function changes around the local optima. A higher absolute value of r suggests a more pronounced peak, whereas a lower absolute value indicates a broader, more gradual peak. By subtracting

$$η \sqrt{\frac{1}{r}} ,$$

launch point determination module 517 shifts the local optima slightly to account for the curvature, providing a more accurate estimate of where the peak actually occurs. The adjustment is helpful in cases where the peak is not symmetric, ensuring that the selected launch points truly represent the most engaging segments.

Guardrails module 518 filters the determined launch points to prevent the selection of launch points that could reveal important plot details or assumed knowledge. The guardrails maintain the integrity of the content's narrative by avoiding spoilers—important plot developments that, if revealed prematurely, could diminish the user's experience. Additionally, guardrails are applied to prevent anti-spoilers, where background information or context that should remain unknown until later in the content item is inadvertently disclosed too early. The guardrail time t_{guardrail} acts as a threshold that filters the potential launch points m. Specifically, after launch point determination module 517 determines the set of local optima m (representing the launch points of the most engaging content segments based on the conditional survival function c(k)), guardrails module 518 applies the guardrail time t_{guardrail} to filter the m values. If a launch point m falls within a time range that could potentially reveal critical plot details or assumed knowledge too early in the content item m<t_{guardrail}, guardrails module 518 filters out the m value, preventing the m value from being selected as a launch point. Guardrail times t_{guardrail} serves as a boundary or constraint that refines the set of m values by excluding values that do not align with the narrative preservation goals. For example, let t_{guardrail} represent the predefined time threshold applied as a guardrail. If the runtime tᵣᵤₙₜᵢₘₑ of a content item is less than 60 minutes, guardrails module 518 set t_{guardrail}=20 minutes to avoid revealing key plot twists that typically occur later in the storyline. Similarly, for longer content items where tᵣᵤₙₜᵢₘₑ≥60 minutes, guardrails module 518 can place a guardrail at around t_{guardrail}=32 minutes. In various embodiments, guardrails module 518 can use metadata tags associated with content segments to identify and exclude potentially problematic launch points. For example, scenes marked with keywords, such as “plot twist,” “final showdown,” “character reveal,” and/or the like, can be automatically identified and avoided as launch points. In some embodiments, guardrails module 518 dynamically adjust guardrails based on user preferences or viewing history. For example, if a user consistently begins watching a series from the first episode, stricter guardrails can be applied to prevent the content item from starting at a point that can reveal spoilers from earlier episodes.

FIG. 7 is a more detailed illustration of recommendation application 546 of FIG. 5, according to various embodiments. Recommendation application 546 processes annotated content items 558 using user inputs 701 and generates one or more recommendations 702. As shown, recommendation application 546 includes, without limitation, data pre-processing module 547 and content presentation module 548. User inputs 701 can be received in various forms, including direct interactions with the content recommendation system 500, such as selecting favorite genres, rating previous content, indicating ‘watch later’ preferences, and/or the like. User inputs 701 can also be received passively through implicit signals, such as monitoring the time of day a user engages with the platform, the type of device they are using (e.g., mobile phone, tablet, smart TV), the user browsing or scrolling behavior within the content library, and/or the like. For example, if a user frequently watches comedy shows on weekend mornings using a tablet, recommendation application 546 can learn to prioritize recommending similar content items during that timeframe. Additionally, user inputs 701 can include voice commands, touch gestures, and even biometric data, such as facial recognition or heart rate available through wearable devices.

Data pre-processing module 547 pre-processes annotated content items 558 and prepares the data for further analysis and recommendation generation. The pre-processing can include filtering out irrelevant data, normalizing engagement metrics across different types of content, or structuring annotated content items 558 into a format that is compatible with the algorithms used in the recommendation application 546. For example, annotated content items 558 can include timestamps for optimal launch points, user engagement peaks, or content segments identified as spoilers. Data pre-processing module 547 can normalize the timestamps to account for varying content lengths, ensuring that launch points are consistent across different types of contents. Additionally, data pre-processing module 547 can filter out content segments that fall below a certain engagement threshold, ensuring that only highly engaging content items are considered for recommendation.

Content presentation module 548 uses user inputs 701 and the pre-processed annotated content items 558 to generate one or more recommendations 702. For example, if a user often skips content introductions and prefers to jump straight into the action segments, content presentation module 548 can prioritize launch points in movies or shows where key plot events or high-action segments begin. Conversely, if user inputs 701 indicate a preference for longer content items during evening hours when the user is likely to have more time, content presentation module 548 can recommend content segments that are rich in narrative depth and less likely to be interrupted. In addition to media content recommendations 702, content presentation module 548 can also be customized to deliver targeted advertisements. For example, if user inputs 701 reveal a preference for cooking shows or food-related content, content presentation module 549 can generate recommendation 702 that include advertisements for kitchen gadgets or meal delivery services at launch points in the recommended content. The timing of the ads can be optimized based on the pre-processed annotated content items 558 which includes launch points. For example, content presentation module 548 can place ads during moments when engagement is predicted to be high, thereby increasing the likelihood of user interaction with the ad. In various embodiments, content presentation module 548 includes additional customizations based on user inputs 701, such as adjusting the content's playback speed, offering alternate language options, or providing personalized recommendations 702 for supplementary content, such as behind-the-scenes footage, interviews with cast members, related content items within the same genre, and/or the like. In some examples, if the user has a premium account, content presentation module 548 removes or reduces the frequency of ads, or suggests exclusive content not available to non-premium users, such as exclusive content, early access to new releases, and/or the like, enhancing the overall user experience. For non-premium members, content presentation module 548 can generate recommendations 702, which include subtle content prompts to encourage subscription. For example, content presentation module 548 can generate recommendations 702 that include a glimpse of exclusive content or provide access to a particularly engaging launch point in a premium content, followed by a suggestion to subscribe for full access.

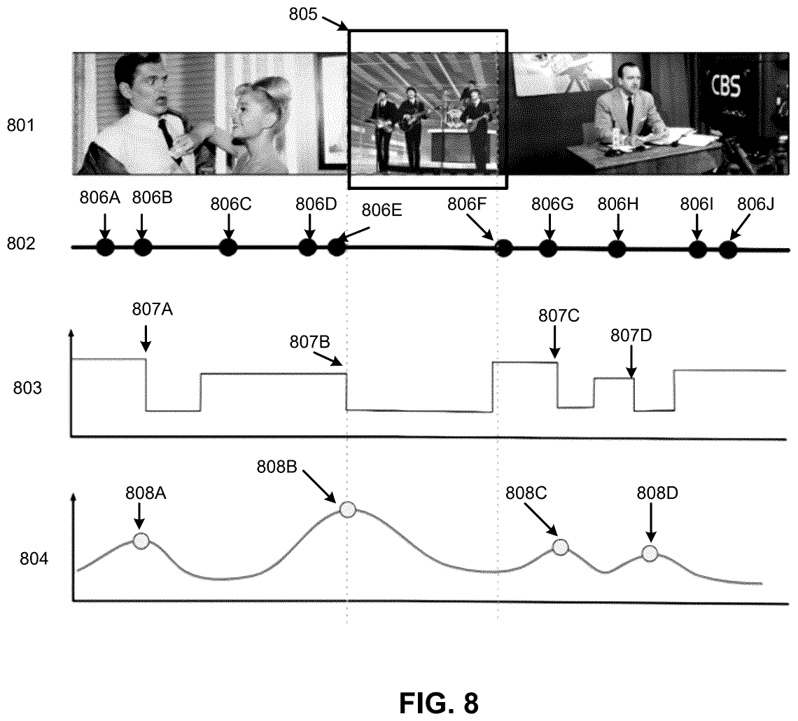

FIG. 8 illustrates an example of the application of the engagement analysis module 515, according to various embodiments. Content 801, such as a movie or TV show, includes a sequence of content segments, such as content segment 805. As shown, content item 801 is shown by images from different content segments and the corresponding content timeline 802 includes various events 806A-806J. Each event 806A-806J included in content item 801 can represent moments when higher user interactions or engagement activities occur, such as a scene change, a plot twist, or a dramatic moment. Hazard rate 803 includes the values of the hazard function, as described in Equations 2 and 3, over time. Hazard rate 803 is a measure of the instantaneous risk of users disengaging from content item 801. The vertical drops in the hazard rate 803 marked as 807A-807D indicate moments where there is a lower likelihood of user disengagement. For example, a sudden drop in hazard rate 803, such as at 807A corresponding to event 806B, can suggest that content item 801 at that moment is successful at retaining user interest. Median conditional survival curve 804 shows the conditional survival times calculated by conditional survival calculation module 516, which indicate how long users will continue to engage with content item 801 beyond specific time points. Conditional survival calculation module 516 smooths conditional survival times included in median conditional survival curve 804, for example, using a 1D Gaussian blur, which helps reduce noise and emphasize broader trends in the conditional survival time data, thereby making identifying the most engaging content segments of content item 801 easier. Launch point determination module 517 uses conditional survival times included in median conditional survival curve 804 to determine launch points 808A-808D. Launch points 808A-808D indicate segments in content item 801 where user engagement peaks. Launch points determination module 517 determines launch points 808A-808D as points where the first derivative of the smoothed curve is zero and the second derivative is negative, as described in Equation 20. Launch point determination module 517 then adjusts the points based on curvature, using the adjustment formula in Equation 21, to ensure that launch points 808A-808D accurately represent the most engaging segments of content item 801. As shown, the highest peak is achieved at launch point 808B, which corresponds to content segment 805. Hence, content segment 805 is the most engaging among content segments of content item 801.

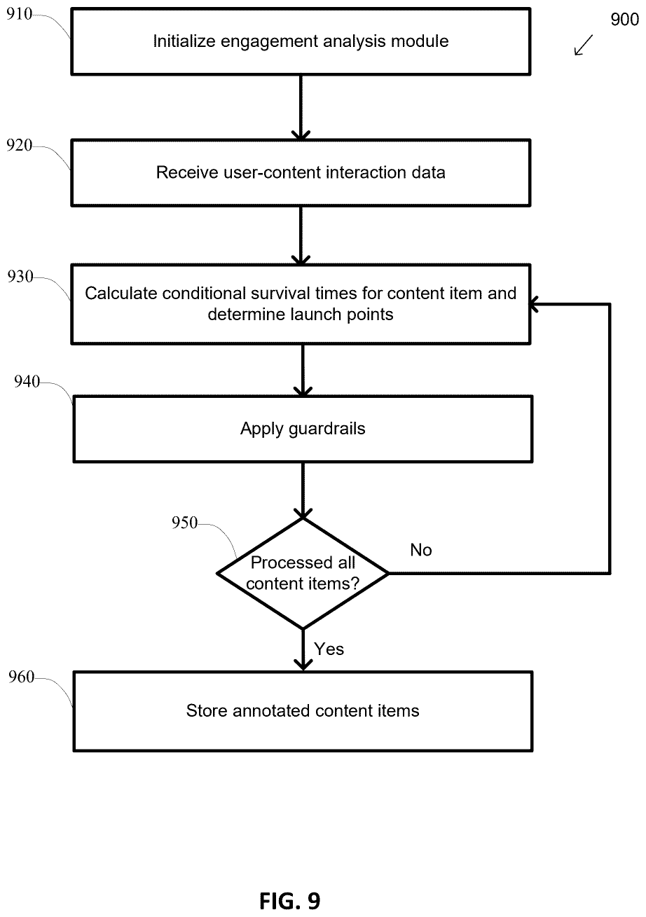

FIG. 9 sets forth a flow diagram of method steps for processing user-content interaction data 557 and generating annotated content items 558, according to various embodiments. Although the method steps are described in conjunction with the systems of FIGS. 1-6 and 8, persons skilled in the art will understand that any system configured to perform the method steps in any order falls within the scope of the present disclosure.

The method 900 begins with step 910, where engagement analysis module 515 is initialized. At step 910, various modules included in engagement analysis module 515 are prepared for operation. In conditional survival calculation module 516, engagement analysis module 515 initializes the algorithms for computing conditional survival functions, and configures various parameters required for survival analysis. For example, the parameters m, v, and p as described in Equation 17 are initialized. In some embodiments, engagement analysis module 515 initializes p in Equation 17 by a grid search. Engagement analysis module 515 also initializes the probability threshold p used in calculating the conditional survival function as defined in Equation 19. In launch point determination module 517, engagement analysis module 515 initializes the algorithms for smoothing, such as configuring the parameters for the Gaussian blur, including the initial and subsequent values of σ used in smoothing the conditional survival time data. Engagement analysis module 515 can also initialize numerical algorithms for determining local optima in the smoothed conditional survival time data. For example, engagement analysis module 515 can initialize the step size for derivative calculations and curvature adjustments, such as initializing n in Equation 21. In guardrails module 518, engagement analysis module 515 initializes predefined rules or criteria that define the guardrails, such as time thresholds (t_{guardrail}), which prevent launch points from being selected near spoiler plot points. In some embodiments, engagement analysis module 515 can load various spoiler time stamps for various contents.

At step 920, engagement analysis module 515 receives user-content interaction data 557. In various embodiments, user-content interaction data 557 is received from various sources, such as user devices, content streaming platforms, content delivery networks, and/or the like. User-content interaction data 557 includes, without limitation, information about how users interact with the content, such as play, pause, rewind, and skip actions, as well as the timing and duration of user interactions.

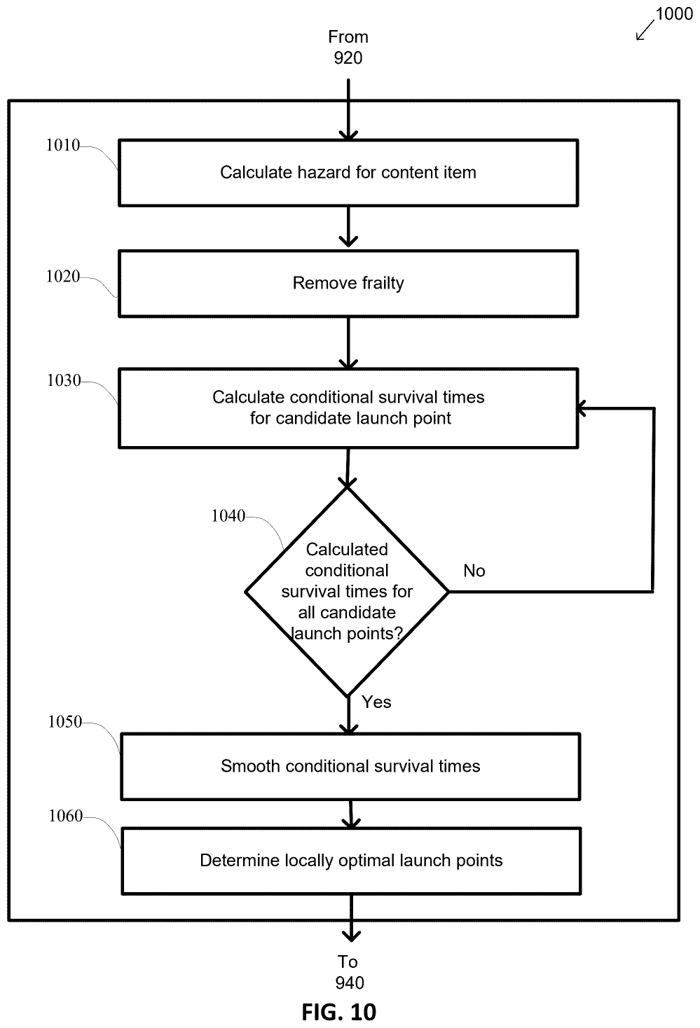

At step 930, engagement analysis module 515 calculates conditional survival times for the content item and determines launch points. In various embodiments, conditional survival calculation module 516 processes user-content interaction data 557 to compute the survival probability, which indicates the likelihood that users will remain engaged with the content item beyond a given time. Conditional survival calculation module 516 also calculates the hazard function, identifying specific moments in the content item where the risk of user disengagement is highest. Conditional survival calculation module 516 then adjusts the hazard functions for frailty, which accounts for the variability in user engagement behavior. Launch point determination module 517 uses conditional survival times to determine locally optimal launch points, which are specific moments in the content item where user engagement is expected to peak. Step 930 is described in further detail in conjunction with FIG. 10.

FIG. 10 sets forth a flow diagram of method steps for calculating conditional survivals times for content item and determining launch points, according to various embodiments. Although the method steps are described in conjunction with the systems of FIGS. 1-6 and 8, persons skilled in the art will understand that any system configured to perform the method steps in any order falls within the scope of the present disclosure.

The method 1000 begins with step 1010, where conditional survival calculation module 516 calculates the hazard for the content. Conditional survival calculation module 516 processes user-content interaction data 557 to calculate the survival probability as described in Equation 1, which represents the likelihood that users will remain engaged with the content item beyond a given time. Conditional survival calculation module 516 then calculates the hazard function as described in Equation 2, identifying specific moments in the content item where the risk of user disengagement is highest. In various embodiments, conditional survival calculation module 516 uses the Kaplan-Meier estimator to handle ties in the event data, such as instances where multiple users disengage at the same time, and generates the estimated survival function as described in Equation 12. In various embodiments, conditional survival calculation module 516 calculates the discrete hazard function at each time point as described in Equation 13, which reflects the immediate risk of disengagement.

At step 1020, conditional survival calculation module 516 removes the frailty. To adjust for frailty, conditional survival calculation module 516 introduces a random variable that scales the baseline hazard function based on unobserved user characteristics, as described in Equation 17. The adjusted hazard function includes a parameter that adjusts for the degree of frailty, an accumulated adjustment factor that accounts for various unobserved influences on user engagement, and additional parameters that further refine the adjustment. In some examples, the accumulated adjustment factor is calculated using the discrete Nelson-Aalen estimator, as outlined in Equation 18. The discrete Nelson-Aalen estimator sums up the hazard contributions at each time point from the start up to a given time, providing a cumulative measure of risk. The contribution at each time point is calculated as the ratio of the number of failures, such as user disengagements, to the number of users still at risk just before that time point. In some embodiments, the parameters of Equation 17 are fixed at step 910 or are determined by a grid search over a specified range to ensure that the adjusted population of users matches a target percentage.

At step 1030, conditional survival calculations module 516 calculates the conditional survival times for candidate launch points. For each potential launch point within the content, conditional survival calculation module 516 uses the discrete Kaplan-Meier estimator to calculate the survival probabilities, as described in Equation 14, with adjustments made for frailty using the hazard function from Equation 17. In some examples, conditional survival calculations module 516 sweeps over various values of the adjustment factor referenced in Equation 14, providing different options for content segments based on user preferences, such as patience and desired content length. The sweep yields groups of content segments with varying maximum lengths, such as 2 minutes, 6 minutes, or 12 minutes, catering to different user engagement patterns. In various embodiments, conditional survival calculations module 516 calculates the conditional survival function as described in Equation 19, which determines the minimum time after a launch point, where the probability of user disengagement remains below a specific threshold. The threshold represents the maximum allowable risk of disengagement for content to be considered engaging. For example, conditional survival calculations module 516 can consider users that are more sensitive to churn and set the probability threshold at an appropriate level (e.g., 0.25).

At step 1040, engagement analysis module 515 checks whether conditional survival times for all candidate launch points are calculated. If the conditional survival times for all candidate launch points are not calculated, the method 1000 proceeds to step 1030. If the conditional survival times for all candidate launch points are calculated, the method 1000 proceeds to step 1050.

At step 1050, launch point determination module 517 smooths the conditional survival times. In various embodiments, launch point determination module 517 smooths the conditional survival times using techniques, such as applying a 1D Gaussian blur, which helps to reduce noise and highlight broader engagement trends. In some examples, the smoothing process begins with larger smoothing parameters, which are gradually reduced to capture finer details in user engagement patterns.

At step 1060, launch point determination module 517 determines the locally optimal points. In various embodiments, launch point determination module 517 determines local optima by examining where the smoothed conditional survival function reaches a local maximum, indicating high user engagement. In at least one embodiment, launch point determination module 517 determines the local optima by checking for specific conditions, such as where the first derivative of the smoothed survival function is zero, indicating a peak or trough, and where the second derivative is negative, confirming a local maximum as described in Equation 20. In some embodiments, launch point determination module 517 calculates the local optima numerically with fine granularity. Once the local optima are determined, launch point determination module 517 performs a curvature adjustment to further refine the launch points, as described in Equation 21. The adjustment, based on the curvature of the conditional survival function, ensures that the selected launch points accurately represent the moments of peak user engagement, even in cases where the engagement peaks are not symmetric.

Referring back to FIG. 9, at step 940, guardrails module 518 applies guardrails. In various embodiments, guardrails module 518 filters and adjusts the launch points determined at step 930 so that the launch points do not reveal plot details, spoilers, or assumed knowledge. Guardrails module 518 also applies guardrails for anti-spoilers, ensuring that context that should remain unknown to maintain suspense or emotional impact is not inadvertently revealed. In some embodiments, guardrails module 518 uses metadata tags associated with content segments to identify and filter potentially problematic launch points. Additionally, guardrails module 518 can dynamically adjust guardrails based on user preferences or viewing history. In some embodiments, guardrails module 518 applies the guardrails based on predefined time thresholds, which can vary depending on the total runtime of the content. For example, if the runtime of the content item is less than 60 minutes, the guardrail can be set at 20 minutes to avoid spoiling plot developments that typically occur later in the storyline. For longer content, where runtime is greater than 60 minutes, guardrails module 518 can apply a guardrail at around 32 minutes.

At step 950, engagement analysis module 515 checks whether all contents are processed. In various embodiments, engagement analysis module 515 checks whether all contents included in user-content interaction data 557 are processed. If all contents included in user-content interaction data 557 are processed, the method 900 proceeds to step 930. If all contents included in user-content interaction data 557 are not processed, the method 900 proceeds to step 960.

At step 960, engagement analysis module 515 stores annotated content items 558. In various embodiments, engagement analysis module 515 annotates content item with the determined launch points and any other relevant metadata, such as specific timestamps or content segments that have been determined to improve user engagement, based on prior user-content interaction data 557. Engagement analysis module 515 stores annotated content items 558 in datastore 520, where annotated content items 558 can be accessed by recommendation application 546 for content recommendation.

FIG. 11 sets forth a flow diagram of method steps for generating recommendations 702 using annotated content items 558 based on user inputs 701, according to various embodiments. Although the method steps are described in conjunction with the systems of FIGS. 1-5 and 7, persons skilled in the art will understand that any system configured to perform the method steps in any order falls within the scope of the present disclosure.

The method 1100 begins with step 1110, where recommendation application 546 receives user inputs 701. User inputs 701 can be received in various forms, including direct interactions with the content recommendation system 500, such as selecting favorite genres, rating previous content, indicating ‘watch later’ preferences, and/or the like. User inputs 701 can also be received passively through implicit signals, such as monitoring the time of day a user engages with the platform, the type of device the user is using, the user's browsing or scrolling behavior within the content library, and/or the like. Additionally, user inputs 701 can include voice commands, touch gestures, and even biometric data, such as facial recognition or heart rate available using wearable devices.

At step 1120, data pre-processing module 547 receives and pre-processes annotated content items 558. In various embodiments, data pre-processing module 547 filters out irrelevant data from annotated content items 558, normalizes engagement metrics across different types of content, and structures annotated content items 558 into a format compatible with the algorithms used in recommendation application 546. For example, annotated content items 558 can include timestamps for optimal launch points, user engagement peaks, or content segments identified as spoilers. Data pre-processing module 547 normalizes the timestamps to account for varying content lengths, ensuring consistency in launch points across different types of content. In at least one embodiment, data pre-processing module 547 filters out content segments that fall below a specified engagement threshold so that only highly engaging content items is considered for recommendation.

At step 1130, recommendation application 546 generates recommendations 702 based on user inputs 701. In various embodiments, content presentation module 548 uses user inputs 701 and pre-processed annotated content items 558 to generate recommendations 702 based on individual user preferences. For example, if a user prefers to skip introductions and jump straight into action content segments, content presentation module 548 can prioritize launch points at plot events that include high-action moments. Additionally, for users with more time during evening hours, content presentation module 548 can generate recommendations 702, which include content segments rich in narrative depth. In some embodiments, content presentation module 548 generates recommendations 702 which include targeted advertisements based on user interests, such as cooking-related ads during food shows, with the timing of ads optimized for high engagement moments. In at least one embodiment, content presentation module 548 generates recommendations 702 which include customizations, such as adjusting playback speed, offering alternate languages, or providing supplementary content. For premium users, content presentation module 548 generates recommendations 702 which can reduce or remove ads and offer exclusive content. For non-premium users, content presentation module 548 generates recommendations 702 which encourage the users to subscribe by showcasing premium content highlights starting from the most engaging launch points.

In sum, the disclosed techniques include a content recommendation system that uses engagement metrics to determine content launch points and generate personalized recommendations. For every content item, the disclosed techniques calculate conditional survival and determine launch points based on user-content interaction data. The determined launch points for content are those that are most likely to result in rapid user engagement and maintain user interest in the recommended content. In various embodiments, the disclosed techniques use guardrails to filter out launch points, which can be content spoilers. Once all contents are processed, the disclosed techniques store annotated content items which includes the determined launch points. The disclosed techniques then process user inputs and use the annotated content items to generate recommendations.

At least one technical advantage of the disclosed techniques relative to prior art is that the disclosed techniques account for dynamic factors influencing user engagement with content, such as the temporal patterns of user interaction with content. Based on conditional survival times and hazard rate calculations, the disclosed techniques more accurately predict when users are most likely to remain engaged with content, leading to more tailored and relevant recommendations. Another advantage of the disclosed techniques is the ability to improve user satisfaction and retention by determining locally optimal launch points that align with peak user engagement moments. These technical advantages provide one or more technological improvements over prior art approaches.
1. In some embodiments, a computer-implemented method for processing user-content interaction data comprises receiving user-content interaction data for a content item, calculating conditional survival times for the content item, determining one or more launch points within the content item based on the calculated conditional survival times, and annotating the content item with the one or more launch points, wherein the one or more launch points are useable to generate recommendations for one or more users.
2. The computer-implemented method of clause 1, wherein calculating the conditional survival times comprises computing a survival probability for each user related event using a Kaplan-Meier estimator.
3. The computer-implemented method of clauses 1 or 2, further comprising determining that a segment of the content item identified by a first launch point from the one or more launch points is associated with a metadata tag indicating that the segment of the content item should not be used as a launch point, and removing the first launch point from the one or more launch points.
4. The computer-implemented method of any of clauses 1-3, further comprising determining that a first launch point of the one or more launch points is outside a time range identified by predefined time thresholds, and removing the first launch point from the one or more launch points.
5. The computer-implemented method of any of clauses 1-4, wherein the user-content interaction data comprises time-series data indicating one or more of viewing duration, skips, or replays of the content item by a plurality of users.
6. The computer-implemented method of any of clauses 1-5, wherein determining the one or more launch points comprises calculating a hazard rate at which users are likely to disengage with the content item at points within the content item, calculating conditional survival rates for segments of the content item based on the hazard rate, and selecting the one or more launch points based on peaks in the conditional survival rates.
7. The computer-implemented method of any of clauses 1-6, wherein calculating the hazard rate for a first time comprises determining a ratio of a first number of users that disengage from the content item at the first time to a second number of users that have consumed the content item to the first time.
8. The computer-implemented method of any of clauses 1-7, wherein the conditional survival rate at a first time indicates a probability that a user who consumed the content item up to the first time will continue to consume the content item for an additional period of time.
9. The computer-implemented method of any of clauses 1-8, further comprising adjusting a curvature of each of the peaks.
10. The computer-implemented method of any of clauses 1-9, further comprising removing frailty by adjusting the hazard rate using a Nelson-Aalen estimator.
11. The computer-implemented method of any of clauses 1-10, further comprising smoothing the conditional survival rates using a Gaussian blur.
12. The computer-implemented method of any of clauses 1-11, wherein smoothing the conditional survival rates comprises setting a standard deviation of the Gaussian blur to an initial value, and gradually reducing the standard deviation.
13. The computer-implemented method of any of clauses 1-12, further comprising generating recommendations based on the annotated content item.
14. In some embodiments, one or more non-transitory computer-readable media include instructions that, when executed by one or more processors, cause the one or more processors to perform the steps of receiving user-content interaction data for a content item, calculating conditional survival times for the content item, determining one or more launch points within the content item based on the calculated conditional survival times, and annotating the content item with the one or more launch points, wherein the one or more launch points are useable to generate recommendations for one or more users.
15. The one or more non-transitory computer-readable media of clause 14, wherein calculating the conditional survival times comprises computing a survival probability for each user related event using a Kaplan-Meier estimator.
16. The one or more non-transitory computer-readable media of clauses 14 or 15, wherein the steps further comprise determining that a first launch point of the one or more launch points is outside a time range identified by predefined time thresholds, and removing the first launch point from the one or more launch points.
17. The one or more non-transitory computer-readable media of any of clauses 14-16, wherein determining the one or more launch points comprises calculating a hazard rate at which users are likely to disengage with the content item at points within the content item, calculating conditional survival rates for segments of the content item based on the hazard rate, and selecting the one or more launch points based on peaks in the conditional survival rates.
18. The one or more non-transitory computer-readable media of any of clauses 14-17, wherein the steps further comprise removing frailty by adjusting the hazard rate using a Nelson-Aalen estimator.
19. The one or more non-transitory computer-readable media of any of clauses 14-18, wherein the steps further comprise smoothing the conditional survival rate using a Gaussian blur.
20. In some embodiments, a system comprises a memory storing instructions, and a processor that is coupled to the memory and, when executing the instructions, is configured to perform the steps of receiving user-content interaction data for a content item, calculating conditional survival times for the content item, determining one or more launch points within the content item based on the calculated conditional survival times, and annotating the content item with the one or more launch points, wherein the one or more launch points are useable to generate recommendations for one or more users. Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

1. A computer-implemented method for processing user-content interaction data, the method comprising:
receiving user-content interaction data for a content item;
calculating conditional survival times for the content item;
determining one or more launch points within the content item based on the calculated conditional survival times; and
annotating the content item with the one or more launch points, wherein the one or more launch points are useable to generate recommendations for one or more users.

2. The computer-implemented method of claim 1, wherein calculating the conditional survival times comprises:
computing a survival probability for each user related event using a Kaplan-Meier estimator.

3. The computer-implemented method of claim 1, further comprising:
determining that a segment of the content item identified by a first launch point from the one or more launch points is associated with a metadata tag indicating that the segment of the content item should not be used as a launch point; and
removing the first launch point from the one or more launch points.

4. The computer-implemented method of claim 1, further comprising:
determining that a first launch point of the one or more launch points is outside a time range identified by predefined time thresholds; and
removing the first launch point from the one or more launch points.

5. The computer-implemented method of claim 1, wherein the user-content interaction data comprises time-series data indicating one or more of viewing duration, skips, or replays of the content item by a plurality of users.

6. The computer-implemented method of claim 1, wherein determining the one or more launch points comprises:
calculating a hazard rate at which users are likely to disengage with the content item at points within the content item;
calculating conditional survival rates for segments of the content item based on the hazard rate; and
selecting the one or more launch points based on peaks in the conditional survival rates.

7. The computer-implemented method of claim 6, wherein calculating the hazard rate for a first time comprises determining a ratio of a first number of users that disengage from the content item at the first time to a second number of users that have consumed the content item to the first time.

8. The computer-implemented method of claim 6, wherein the conditional survival rate at a first time indicates a probability that a user who consumed the content item up to the first time will continue to consume the content item for an additional period of time.

9. The computer-implemented method of claim 6, further comprising adjusting a curvature of each of the peaks.

10. The computer-implemented method of claim 6, further comprising removing frailty by adjusting the hazard rate using a Nelson-Aalen estimator.

11. The computer-implemented method of claim 6, further comprising smoothing the conditional survival rates using a Gaussian blur.

12. The computer-implemented method of claim 11, wherein smoothing the conditional survival rates comprises:
setting a standard deviation of the Gaussian blur to an initial value; and
gradually reducing the standard deviation.

13. The computer-implemented method of claim 1, further comprising generating recommendations based on the annotated content item.

14. One or more non-transitory computer-readable media including instructions that, when executed by one or more processors, cause the one or more processors to perform the steps of:
receiving user-content interaction data for a content item;
calculating conditional survival times for the content item;
determining one or more launch points within the content item based on the calculated conditional survival times; and
annotating the content item with the one or more launch points, wherein the one or more launch points are useable to generate recommendations for one or more users.

15. The one or more non-transitory computer-readable media of claim 14, wherein calculating the conditional survival times comprises:
computing a survival probability for each user related event using a Kaplan-Meier estimator.

16. The one or more non-transitory computer-readable media of claim 14, wherein the steps further comprise:
determining that a first launch point of the one or more launch points is outside a time range identified by predefined time thresholds; and
removing the first launch point from the one or more launch points.

17. The one or more non-transitory computer-readable media of claim 14, wherein determining the one or more launch points comprises:
calculating a hazard rate at which users are likely to disengage with the content item at points within the content item;
calculating conditional survival rates for segments of the content item based on the hazard rate; and
selecting the one or more launch points based on peaks in the conditional survival rates.

18. The one or more non-transitory computer-readable media of claim 17, wherein the steps further comprise removing frailty by adjusting the hazard rate using a Nelson-Aalen estimator.

19. The one or more non-transitory computer-readable media of claim 17, wherein the steps further comprise smoothing the conditional survival rate using a Gaussian blur.

20. A system comprising:
a memory storing instructions; and
a processor that is coupled to the memory and, when executing the instructions, is configured to perform the steps of:
receiving user-content interaction data for a content item;
calculating conditional survival times for the content item;
determining one or more launch points within the content item based on the calculated conditional survival times; and
annotating the content item with the one or more launch points, wherein the one or more launch points are useable to generate recommendations for one or more users.
